(19) United States
(12) Patent Application Publication
(10) Pub. No.: US 2025/0392385 A1
(43) Pub. Date: Dec. 25, 2025

(54) MONITORING DEVICE, MONITORING METHOD AND MONITORING PROGRAM

(71) Applicant: NTT, Inc., Tokyo (JP)

(72) Inventors: Takashi KUBO, Musashino-shi, Tokyo (JP); Hiroki DATE, Musashino-shi, Tokyo (JP); Kohei WATANABE, Musashino-shi, Tokyo (JP); Kenichi AOYAGI, Musashino-shi, Tokyo (JP); Daisaku Shimazaki, Musashino-shi, Tokyo (JP); Hideki Maeda, Musashino-shi, Tokyo (JP)

(21) Appl. No.: 18/839,901

(22) PCT Filed: Feb. 25, 2022
(86) PCT No.: PCT/JP2022/008084

§ 371 Date: Feb. 24, 2025

(51) Int. Cl. H04B 10/079; H04J 14/02

(52) U.S. Cl. CPC H04B 10/07955; H04J 14/02

(57) ABSTRACT

A data acquisitor of a monitoring device acquires a power value of a range including an entire wavelength of a target channel and acquires power values of ranges including parts of the wavelength of the target channel, from an optical channel monitor that measures power values of optical signals output from nodes. A determinator compares each of the power values with threshold values based on power values of the nodes in a steady state and determines abnormality in the nodes

### CROSS-REFERENCE TO RELATED APPLICATIONS

This application is a National Stage application under 35 U.S.C. § 371 of International Application No. PCT/JP2022/008084, having an International Filing Date of Feb. 25, 2022.

The disclosure of the prior application is considered part of the disclosure of this application, and is incorporated by reference in its entirety into this application.

### TECHNICAL FIELD

The present invention relates to a monitoring device, a monitoring method and a monitoring program.

### BACKGROUND ART

In an optical transmission system, an optical path that is a communication path of optical signals is constructed by a plurality of nodes connected to each other by optical fibers. In an optical path, a transmission end node and a reception end node are connected via a plurality of relay nodes.

If abnormality occurs in any of the plurality of nodes constituting the optical path, the abnormality affects the quality of optical signals transmitted through the optical path, and identification of the node where the abnormality has occurred is thus required.

For example, determination of abnormality in a node by providing a high-resolution monitor such as an optical spectrum analyzer (OSA) at each node and accurately recognizing the waveform shape of an optical signal output from the node by using a monitoring device has been proposed (see Non Patent Literature 1, for example).

### CITATION LIST

### Non Patent Literature

Non Patent Literature 1: Behnam Shariati, et al. “Learning From the Optical Spectrum: Failure Detection and Identification” JOURNAL OF LIGHTWAVE TECHNOLOGY, VOL. 37, NO. 2 (2019)

### SUMMARY OF INVENTION

### Technical Problem

However, if the high-resolution monitor is provided at each node, then installation costs of the optical transmission system become high. Since the amount of data transmitted from each monitor to the monitoring device also increases, a communication load increases.

An improvement in accuracy of determining abnormality in a node has been required while reducing monitor installation costs and a monitor communication load in the monitoring device.

### Solution to Problem

A monitoring device according to the present invention includes: a data acquisitor that acquires a first power value of a first range including an entire wavelength of channels and acquires a second power value of a second range including a part of the wavelength of the channels from a monitor measuring power values of optical signals output from a transmission device; and a determinator that compares each of the first power value and the second power value with a threshold value based on a power value of the transmission device in a steady state and determines abnormality in the transmission device.

### Advantageous Effects of Invention

According to the present invention, it is possible to improve accuracy of determining abnormality in a node while reducing monitor installation costs and a monitor communication load.

### BRIEF DESCRIPTION OF DRAWINGS

FIG. 1 is a conceptual diagram of an optical transmission system to which a monitoring device is applied according to an embodiment.

FIG. 2 is a diagram illustrating a configuration of a node.

FIG. 3 is a diagram illustrating waveforms of optical signals of a plurality of channels output from a WSS.

FIG. 4 is a functional block diagram illustrating a configuration of the monitoring device.

FIG. 5 is a diagram for explaining a range in which a data acquisitor acquires a power value.

FIG. 6 is a diagram for explaining an example of abnormality in a waveform caused by abnormality in a filter function of the WSS.

FIG. 7 is a diagram for explaining an aspect in which a power value is acquired for a waveform with abnormality having occurred therein.

FIG. 8 is a diagram for explaining an example of threshold value setting.

FIG. 9 is a diagram for explaining an example of abnormality determination processing.

FIG. 10 is a flowchart illustrating a flow of the abnormality determination processing.

FIG. 11 is a flowchart illustrating a flow of threshold value setting processing.

FIG. 12 is a hardware configuration diagram illustrating an example of a computer that realizes a function of the monitoring device according to the present embodiment.

FIG. 13 is a diagram for explaining a range in which a power value is acquired according to a modified embodiment 1.

FIG. 14 is a diagram for explaining a comparative example.

FIG. 15 is a flowchart illustrating a flow of abnormality determination processing according to the modified embodiment 1.

FIG. 16 is a diagram for explaining a range in which a power value is acquired according to a modified embodiment 2.

FIG. 17 is a functional block diagram illustrating a configuration of a monitoring device according to a modified embodiment 3.

FIG. 18 is a flowchart illustrating a flow of threshold value correction processing according to the modified embodiment 3.

### DESCRIPTION OF EMBODIMENTS

Next, an embodiment for carrying out the present invention (hereinafter, referred to as a “present embodiment”) will be described with reference to the drawings. In the present embodiment, an example in which a monitoring device is applied to an optical transmission system will be described.

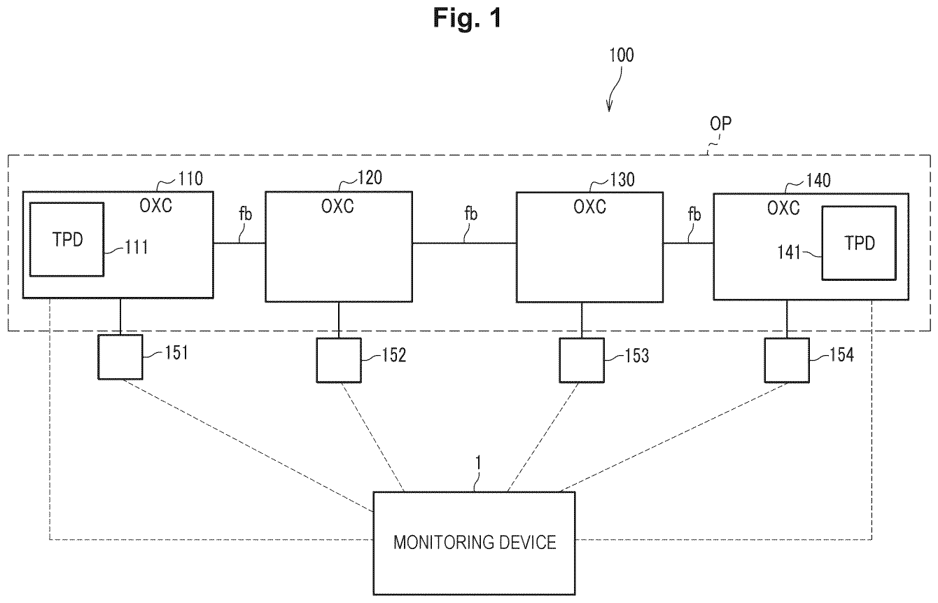

FIG. 1 is a conceptual diagram of an optical transmission system to which the monitoring device is applied according to the present embodiment.

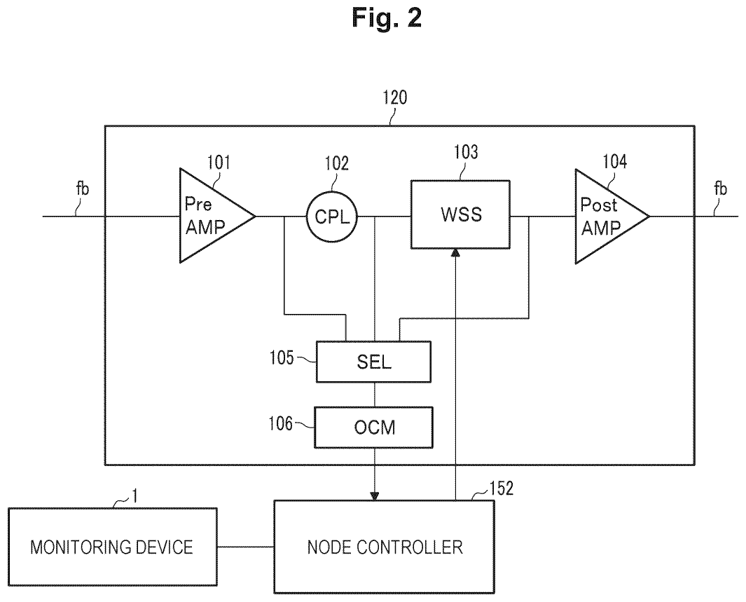

FIG. 2 is a diagram illustrating a configuration of a node.

As illustrated in FIG. 1, an optical transmission system 100 has a plurality of nodes connected to each other by optical fibers fb that are optical transmission paths. FIG. 1 illustrates an example in which an optical path OP that is a communication path of an optical signal is constituted by four nodes 110, 120, 130, and 140. An example in which an optical signal is transmitted from the node 110 to the node 140 through the optical path OP is illustrated. In other words, the node 110 is a transmission end node, the node 140 is a reception end node, and the nodes 120 and 130 are relay nodes.

Note that although FIG. 1 shows an example in which the plurality of nodes 110, 120, 130, and 140 are connected in series in the optical transmission system 100, the nodes may be connected in a mesh shape or a ring shape. In other words, each node can be connected to other nodes, which are not illustrated and can output and input optical signals to and from other nodes.

Each of the nodes 110, 120, 130, and 140 is configured as a transmission device. The transmission device may be, for example, an optical cross connect (OXC) device. Each of the nodes 110, 120, 130, and 140 transmits an optical wavelength multiplexed signal in which optical signals of a plurality of channels are wavelength-multiplexed. Although not illustrated, an in-line amplifier (InLine-Amplifier, ILA) that amplifies the optical wavelength multiplexed signal may be provided between the nodes 110, 120, 130, and 140 of the optical path OP.

The transmission end node 110 and the reception end node 140 include transponders (TPD) 111 and 141 that are transceivers, respectively. Note that, although not illustrated, the nodes 120 and 130 as relay nodes may also include transponders, and the nodes 120 and 130 may be transmission end nodes or reception end nodes in another optical path OP.

The transmission end node 110 performs wavelength multiplexing on an optical signal input from the transponder 111 and outputs an optical wavelength multiplexed signal. The relay nodes 120 and 130 separate optical signals included in the input optical wavelength multiplexed signal. The relay nodes 120 and 130 again perform wavelength multiplexing on the separated optical signals and output an optical wavelength multiplexed signal. The reception end node 140 separates the optical signals included in the input optical wavelength multiplexed signal and receives the optical signals by the transponder 141.

Although the nodes 110 to 140 have the same configuration, FIG. 2 illustrates the configuration of the node 120 as a representative.

As illustrated in FIG. 2, the node 120 includes a pre-stage amplifier 101, a coupler (CPL) 102, a wavelength selective switch (Wave Selective Switch, hereinafter also referred to as “WSS”) 103, a post-stage amplifier 104, a selector (SEL) 105, an optical channel monitor (OCM) 106, and the like. The node 120 also includes a node controller 152 that controls operations of the node 120.

An output side of the pre-stage amplifier 101 is connected to an input side of the post-stage amplifier 104 via the coupler 102 and the WSS 103. The selector 105 selects any one of the output of the pre-stage amplifier 101, the output of the coupler 102, and the output of the WSS 103 and outputs the selected output to the optical channel monitor 106.

The optical channel monitor 106 (monitor) measures the output power of the pre-stage amplifier 101, the coupler 102, or the WSS 103 input from the selector 105. A measurement value of the output power of the WSS 103 is used in abnormality determination processing of the monitoring device 1, which will be described later. The measurement value is input to the node controller 152.

The pre-stage amplifier 101 amplifies the optical wavelength multiplexed signal input from the optical fiber fb, which is an optical transmission path, and inputs the optical wavelength multiplexed signal to the WSS 103.

The WSS 103 separates the optical wavelength multiplexed signal into optical signals of a plurality of channels. The WSS 103 outputs the separated optical signals to a set output destination. The WSS 103 outputs an optical signal to be dropped to a transponder (not illustrated). The WSS 103 inputs the optical signal to be added input from the transponder to a set channel, multiplexes the optical signal to be added together with the optical signal to be passed through, generates an optical wavelength multiplexed signal, and inputs the optical wavelength multiplexed signal to the post-stage amplifier 104. The post-stage amplifier 104 amplifies the optical wavelength multiplexed signal and outputs the optical wavelength multiplexed signal to the optical fiber fb.

Although not illustrated, the WSS 103 includes, for example, an array type light beam deflecting element such as a liquid crystal on silicon (LCOS). LCOS has a two-dimensional matrix structure of several millions of pixels, and can allocate a plurality of control pixels to an optical signal. In this manner, the WSS 103 can change the passing band of the optical signal for each channel under the control of the node controller 152 regardless of the hardware configuration. In other words, the WSS 103 has a filter function of filtering the optical signal of each channel to the wavelength band set by the node controller 152.

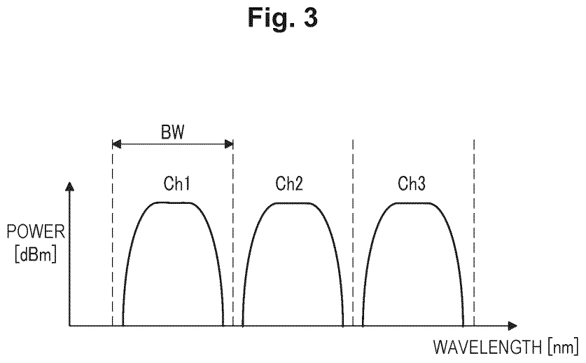

FIG. 3 is a diagram illustrating waveforms of optical signals of a plurality of channels Ch1, Ch2, and Ch3 output from the WSS 103. Although three channels Ch1, Ch2, and Ch3 are illustrated in FIG. 3, the number of channels is arbitrary.

The node controller 152 divides the entire available wavelength band by a grid width, and allocates the respective wavelength bands BW to the channels Ch1, Ch2, and Ch3. The grid width is variable from 12.5 GHz as a minimum unit to 12.5 GHz, 25 GHz, 50 GHz, and 100 GHz. In other words, the node controller 152 can change the number of channels and the width of each wavelength band BW by changing the grid width.

FIG. 3 illustrates waveforms in a state (a steady state) where the filter function of the WSS 103 functions normally. In the steady state, the waveforms of the channels Ch1, Ch2, and Ch3 have a substantially horizontally symmetrical shape and have a gentle peak at the center.

Note that, in the following description, the channels Ch1, Ch2, and Ch3 will also simply be referred to as channels Ch unless it is necessary to distinguish the channels Ch1, Ch2, and Ch3.

Although not illustrated, the WSS 103 includes a variable optical attenuator. The WSS 103 attenuates and multiplexes the optical signals of the channels Ch1 to Ch3. The attenuation amount of the variable optical attenuator is controlled by the node controller 152. The node controller 152 acquires the measurement value of the optical power in units of channels Ch from the optical channel monitor 106. The node controller 152 controls the attenuation amount of the variable optical attenuator on the basis of the measurement value. The node controller 152 performs power control so as to compensate for a power loss caused by the WSS 103 filtering the optical signal of each channel Ch.

The optical channel monitor 106 measures the power value of the optical signal of each channel Ch. The optical channel monitor 106 cuts out the optical signal of each channel Ch input from the selector 105 with a filter, and measures the total value of the power in the cut-out range. The optical channel monitor 106 can change the cut-out range of the optical signal by changing the setting of the resolution of the filter. The resolution setting of the optical channel monitor 106 is controlled by the node controller 152. In abnormality determination processing of the monitoring device 1, which will be described later, the node controller 152 measures power values in a plurality of ranges while changing the resolution of the optical channel monitor 106.

As illustrated in FIG. 1, the nodes 110, 120, 130, and 140 include node controllers 151, 152, 153, and 154, respectively. The monitoring device 1 is connected to each of the node controllers 151, 152, 153, and 154 via a communication network. The monitoring device 1 is further connected to the transponders 111 and 141 provided at the transmission end node 110 and the reception end node 140 via a communication network.

The transponders 111 and 141 include chips for digital signal processing (DSP) therein, and monitor quality of the optical signal transmitted through the optical path OP by utilizing surplus resources. As a monitoring method, a known method described in JP 2020 088628 A can be used, for example. In a case where deterioration in signal quality is detected, the transponders 111 and 141 input a notification to the monitoring device 1. The notification includes information for specifying the optical signal in which the deterioration has been detected. If the abnormality in the transponders 111 and 141 themselves is specified as a cause of the deterioration, the notification includes information indicating the abnormality in the transponders 111 and 141.

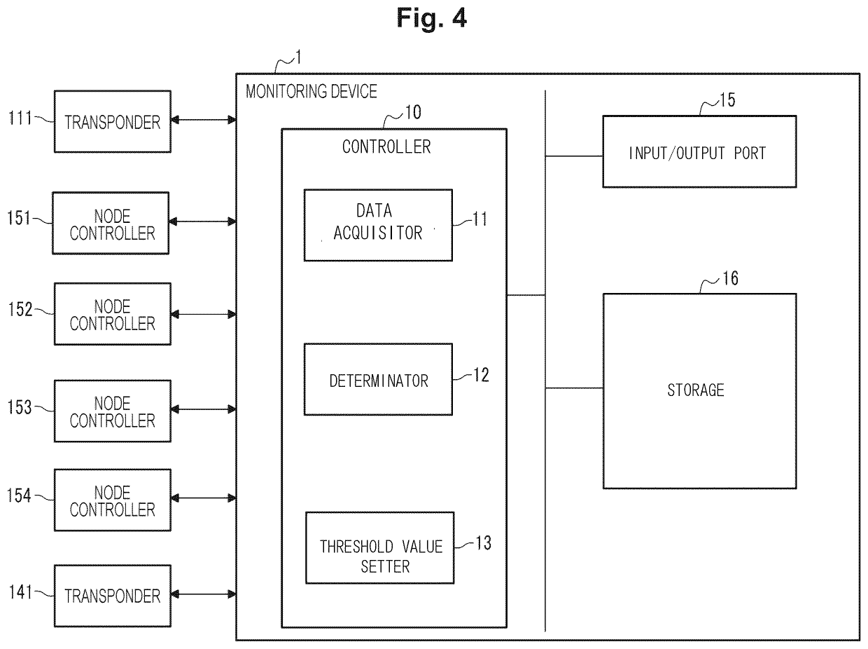

FIG. 4 is a functional block diagram illustrating a configuration of the monitoring device 1.

The monitoring device 1 can be configured as, for example, a network controller that manages the entire optical transmission system 100. In other words, the monitoring device 1 communicates with the node controllers 151, 152, 153, and 154 and the transponders 111 and 141 to control them and monitor abnormality in the optical transmission system 100.

As illustrated in FIG. 4, the monitoring device 1 includes a controller 10, an input/output port 15, and a storage 16.

The input/output port 15 inputs/outputs data to/from the node controllers 151, 152, 153, and 154 and the transponders 111 and 141. The input/output port 15 is configured of a communication interface that transmits and receives information via a communication line and an input/output interface that inputs and outputs information between an input device such as a keyboard and an output device such as a display, which are not illustrated.

Furthermore, the storage 16 stores a program (monitoring program) for causing each functional unit of the controller 10 to be executed and information necessary for processing of the controller 10. In an example, the storage 16 stores identification information, configuration information, and the like of the nodes 110, 120, 130, and 140. Further, the storage 16 stores path information including channel allocation information of each optical signal transmitted through the optical path OP. In addition, the storage 16 stores information such as a threshold value used in abnormality determination processing, which will be described later.

The controller 10 is responsible for overall processing executed by the monitoring device 1. In a case where a notification of deterioration in signal quality is input from the transponders 111 and 141 and the notification does not include abnormality in the transponders 111 and 141 themselves, the controller 10 performs abnormality determination processing on the nodes 110, 120, 130, and 140. The controller 10 thus specifies a node in which abnormality has occurred.

The controller 10 is configured to include a data acquisitor 11, a determinator 12, and a threshold value setter 13.

The data acquisitor 11 specifies the optical signal in which the deterioration has been detected from the notification of the transponder 141. The data acquisitor 11 refers to path information stored in the storage 16 and specifies a channel Ch (hereinafter, referred to as a “target channel Tch”) that is the path of the optical signal that has deteriorated.

The data acquisitor 11 communicates with the node controllers 151, 152, 153, and 154, and causes the optical channel monitor 106 of each of the nodes 110, 120, 130, and 140 to measure the power value of the target channel Tch. The node controllers 151, 152, 153, and 154 control the optical channel monitor 106 and the selector 105 (see FIG. 2) to cause the optical channel monitor 106 to measure the power value of the target channel Tch output from the WSS 103. The node controllers 151, 152, 153, and 154 acquire the measurement values of the optical channel monitor 106 and input the measurement values into the data acquisitor 11.

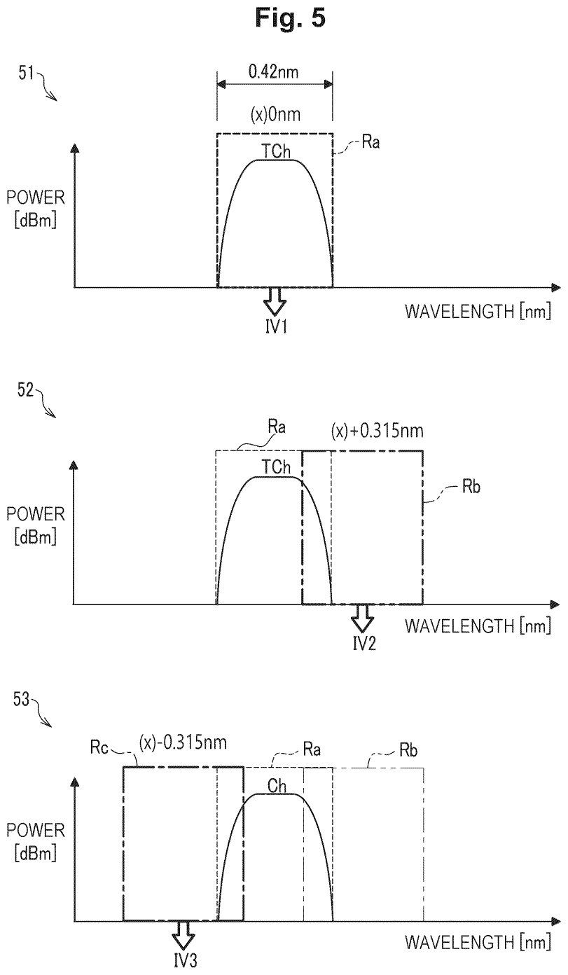

FIG. 5 is a diagram for explaining a range in which the data acquisitor 11 acquires the power value.

The data acquisitor 11 acquires the power values IV1, IV2, and IV3 in the three ranges Ra, Rb, and Rc for the target channel Tch from the optical channel monitor 106.

As illustrated in a diagram of the reference sign 51 in FIG. 5, the data acquisitor 11 acquires the power value IV1 of the range Ra including the entire wavelength of the optical signal of the target channel Tch.

As illustrated in a diagram of the reference sign 52 in FIG. 5, the data acquisitor 11 acquires the power value IV2 of the range Rb including a part of the wavelength of the optical signal of the target channel Tch.

As illustrated in a diagram of the reference sign 53 in FIG. 5, the data acquisitor 11 acquires the power value IV3 of the range Rc including a part of the wavelength of the optical signal of the target channel Tch and located at a position deviated from the range Rb.

The power value IV1 corresponds to the first power value, and the power values IV2 and IV3 correspond to the second power values.

The optical channel monitor 106 changes the resolution of the filter, cuts out the light of the ranges Ra, Rb, and Rc from the optical signal, and measures the power values IV1, IV2, and IV3. The power value means a total value of power in each range, that is, an integral value of power.

The widths of the ranges Ra, Rb, and Rc are determined in accordance with the wavelength band BW (see FIG. 3) allocated to each channel Ch. In FIG. 5, the widths of the ranges Ra, Rb, and Rc are 0.42 nm in a case where the grid width is 50 GHz in an example. The widths of the ranges Rb and Rc may be the same as or different from that of the range Ra.

It is only necessary for the ranges Rb and Rc to be set at mutually deviating positions, and the positions are not limited. The positions of the ranges Rb and Rc may be positions that are symmetrical with the range Ra interposed therebetween, for example. The ranges Rb and Rc may be set so as to partially overlap each other, or may be set so as to be spaced apart from each other.

In FIG. 5, the position of the range Rb is (X+0.315 nm), and the position of the range Rc is (X−0.315 nm) in a case where the position of the range Ra is (X), in an example.

The determinator 12 compares the power values IV1, IV2, and IV3 acquired by the data acquisitor 11 with threshold values TH1, TH2, and TH3, respectively. The threshold values TH1, TH2, and TH3 are set in advance by a threshold value setter 13, which will be described later, and are stored in the storage 16. The threshold values TH1, TH2, and TH3 are set on the basis of the power values of the ranges Ra, Rb, and Rc in the steady state, respectively.

The determinator 12 calculates differences D1, D2, and D3 between the power values IV1, IV2, and IV3 and the threshold values TH1, TH2, and TH3 as absolute values. In a case where any one of the differences D1, D2, and D3 exceeds a predetermined value PD, the determinator 12 determines that abnormality has occurred in the node. The determinator 12 notifies the user of the determination result via the input/output port 15.

The power values IV1 to IV3 are acquired to recognize abnormality in the nodes 110, 120, 130, and 140. In particular, the power values IV2 and IV3 are acquired to recognize abnormality in the waveform of the optical signal caused by abnormality in the filter function of the WSS 103.

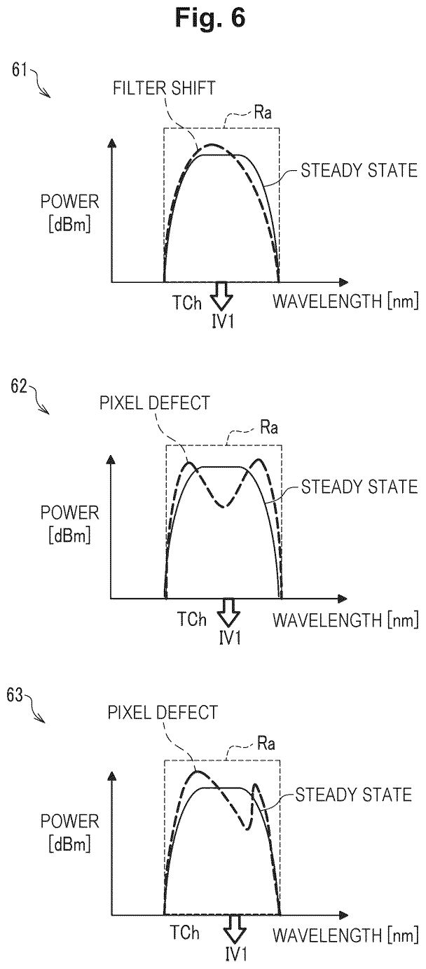

FIG. 6 is a diagram for explaining an example of abnormality in a waveform caused by abnormality in the filter function of the WSS 103.

In the diagrams of the reference signs 61 to 63 in FIG. 6, the waveform in the steady state is indicated by a solid line, and the waveform in which abnormality has occurred is indicated by a dashed line.

In a case of the steady state, the waveform has a substantially horizontally symmetrical shape and has a gentle peak at the center as described above. If abnormality occurs in the filter function of the WSS 103, the waveform may be distorted.

The diagram of the reference sign 61 in FIG. 6 illustrates abnormality in a waveform called a filter shift. As illustrated in the drawing of the reference sign 61, the waveform of the filter shift is horizontally asymmetric, and the peak protrudes more greatly than in the steady state on the left side of the center.

The diagram of the reference sign 62 and the diagram of the reference sign 63 illustrate abnormality in a waveform called pixel defect. The pixel defect means a state in which pixel defect has occurred in the LCOS that filters the optical signal in the WSS 103. While the waveform in the steady state has a gentle peak at the center, the waveform of the pixel defect has a large sharp drop in power at the peak portion as illustrated in the diagram of the reference sign 62 and the diagram of the reference sign 63. As illustrated in the diagram of the reference sign 62, the sudden power drop may occur at the center of the waveform, or as illustrated in the diagram of the reference sign 63, the sudden drop in power may occur to the right or left of the center.

Such abnormality in the waveform may lead to deterioration of quality of the optical signal, and the monitoring device 1 is thus required to specify the node as a cause of the abnormality in the waveform. It is possible to accurately recognize the abnormality in the waveform as in the drawings of the reference sign 61 to the reference sign 63 in FIG. 6 and to determine the abnormality in the node by using a high-resolution monitor such as an OSA, for example. However, providing an OSA at each of the nodes 110, 120, 130, and 140 leads to an increase in installation costs. Furthermore, an increase in amount of data transmitted to the monitoring device 1 from the OSA leads to an increase in communication load.

In the present embodiment, the optical channel monitor 106 provided in each of the nodes 110, 120, 130, and 140 measures the power value with the resolution set in accordance with the wavelength band BW of the target channel Ch as described above. In other words, the optical channel monitor 106 measures the power values with lower resolution than that of the OSA. The installation costs and the communication load are reduced as compared with the OSA by lowering the resolution of the optical channel monitor 106. However, it is not possible to recognize the abnormality in the accurate waveform as illustrated in the diagrams of the reference signs 61 to 63 in FIG. 6 from the power values measured by the optical channel monitor 106,

In the present embodiment, each of the power values IV1, IV2, and IV3 acquired from the plurality of ranges Ra, Rb, and Rc is compared with the threshold values TH1, TH2, and TH3 in order to determine abnormality in the node by using the optical channel monitor 106 set to a low resolution.

First, in a case where the power value IV1 measured from the range Ra covering the entire wavelength is greatly different from the threshold value TH1 based on the steady state, it is possible to determine that abnormality has occurred in the nodes 110, 120, 130, and 140.

However, it may not be possible to determine abnormality in the waveform caused by abnormality in the filter function of the WSS 103 as illustrated in the drawings of the reference sign 61 to the reference sign 63 in FIG. 6 through the comparison between the power value IV1 and the threshold value TH1.

As described above, the node controllers 151, 152, 153, and 154 perform power control to compensate for A loss caused by the filtering of the WSS 103. Similar power control is also performed in a case where a loss occurs due to abnormality in the filter function of the WSS 103.

As illustrated in the diagram of the reference sign 61 in FIG. 6, the power peak on the left side protrudes more greatly than that in the steady state in the waveform of the filter shift, while the power on the right side is smaller than that in the steady state. In other words, power control is performed such that the power of the entire wavelength becomes the same. In this case, the difference D1 between the power value IV1 of the range Ra covering the entire wavelength and the threshold value TH1 may not become large to exceed the predetermined value PD. As illustrated in the diagram of the reference sign 62 and the diagram of the reference sign 63 in FIG. 6, both sides of a location where a sudden power drop has occurred have higher power than that in the steady state in the waveform of the pixel defect. In other words, power control is performed such that the power of the entire wavelength becomes the same. In this case, the difference D1 between the power value IV1 of the range Ra covering the entire wavelength and the threshold value TH1 may not become large to exceed the predetermined value PD.

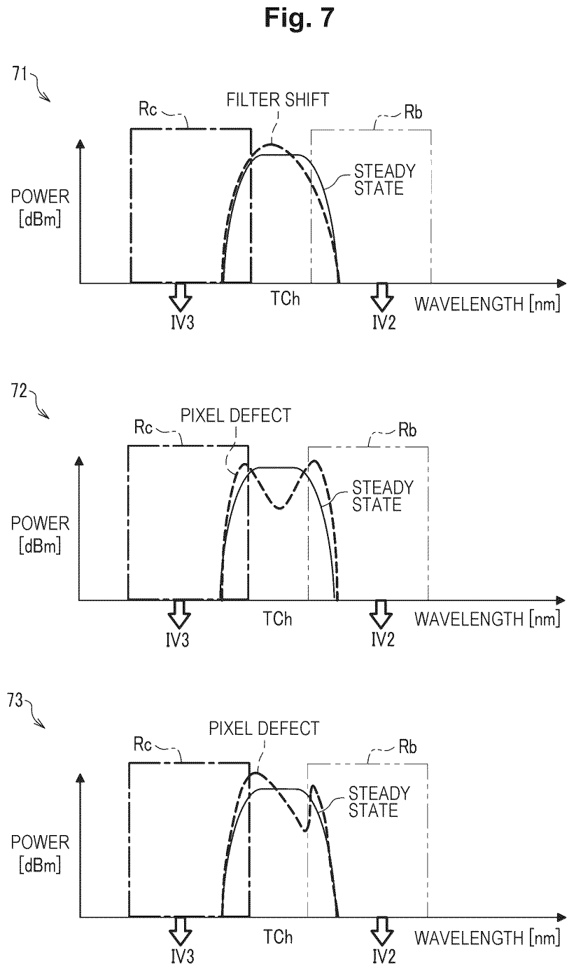

FIG. 7 is a diagram for explaining an aspect in which the power values IV2 and IV3 are acquired from the ranges Rb and Rc for the waveform with abnormality having occurred therein.

As illustrated in the diagrams of the reference sign 71 to the reference sign 73 in FIG. 7, a location with a large power difference between the waveform with abnormality occurring therein and the steady state is likely to be included by setting the ranges Rb and Rc including parts of the wavelength.

As illustrated in the diagram of the reference sign 71, for example, the range Rb includes a portion with lower power than that in the steady state on the right side of the waveform of the filter shift. Therefore, the difference D2 between the power value IV2 of the range Rb and the threshold value TH2 tends to be large. The range Rc includes a part with higher power than that in the steady state on the left side of the waveform of the filter shift. Therefore, the difference D2 between the power value IV3 of the range Rc and the threshold value TH3 tends to be large.

The diagram of the reference sign 72 in FIG. 7 illustrates pixel defect in which a sudden power drop has occurred at the center of the waveform, and each of the ranges Rb and Rc include portions where the power on both end sides increases. Therefore, the differences D2 and D3 between the power values IV2 and IV3 of the ranges Rb and Rc and the threshold values TH2 and TH3 tend to be large.

The diagram of the reference sign 73 in FIG. 7 illustrates pixel defect in which a sudden power drop has occurred on the right side of the waveform, and the range Rb lies across the portion where sudden power drop has occurred and the portion where power rise has occurred. In this case, the difference D2 between the power value IV2 of the range Rb and the threshold value TH2 may not be large. However, since the range Rc includes only the location where the power has risen, the difference D3 between the power value IV3 of the range Rc and the threshold value TH3 tends to be large.

The setting of the ranges Rb and Rc including parts of the wavelength in this manner facilitates capturing of a location where the difference in power from that in the steady state is large. As illustrated in the diagram of the reference sign 73 in FIG. 7, even in the range Rb including a part of the wavelength, the difference in power from that in the steady state may not become large if compensation for a power loss is performed within the range. Even in that case, it is possible to increase the probability that the location with a large difference in power from that in the steady state is captured by setting the plurality of ranges Rb and Rc.

According to such a method, it is possible to improve accuracy of determining the abnormality in the nodes 110, 120, 130, and 140 even in a case where the measurement values acquired from the optical channel monitor 106 with low resolution are used.

Furthermore, it is possible to determine that abnormality in component other than the WSS 103 is a cause in a case where abnormality is determined with the power value IV1, and it is possible to determine that abnormality in the WSS 103 is a cause in a case where abnormality is determined with the power values IV2 and IV3 as described above. In other words, it is also possible to perform cutting-out of the abnormal portion in a node in which abnormality has occurred in addition to the specification of the node, by acquiring the power values IV1, IV2, and IV3.

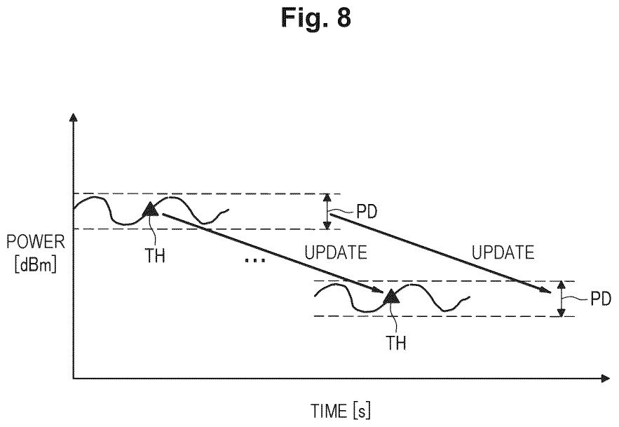

FIG. 8 is a diagram for explaining an example of threshold value setting.

Since the threshold values TH1, TH2, and TH3 can be set by the same method, the threshold values TH1, TH2, and TH3 are collectively expressed as a threshold value TH in FIG. 8.

Once switching such as wave amplification, wave attenuation, and a change in path of the optical signal transmitted through the optical path OP is performed, the power value of the channel, which serves as a path of the optical signal after the switching, in the steady state varies. Therefore, the threshold value setter 13 updates the threshold values TH1, TH2, and TH3 in accordance with the switching of the optical signal. The threshold value setter 13 stores the updated threshold values TH1, TH2, and TH3 in the storage 16. The storage 16 stores threshold values TH1, TH2, and TH3 set for each channel.

The threshold value setter 13 acquires the time-series data of each channel by acquiring the measurement value of the output power of the WSS 103 measured by the optical channel monitor 106 for a certain period of time via the node controllers 151, 152, 153, and 154 of the nodes 110, 120, 130, and 140. The threshold value setter 13 acquires the time-series data for each of the ranges Ra, Rb, and Rc.

FIG. 8 illustrates, as an example, time-series data obtained when the grid width is changed from 50 GHz to 12.5 GHz. The threshold value setter 13 can set, for example, a median value of power as the threshold value TH.

Furthermore, the variation width is set as the predetermined value PD. In this manner, no abnormality is determined if the difference between the threshold value TH and the power value is within a range of the variation width in the steady state, and erroneous determination is thus reduced.

In a case where the variation width in the time-series data is large, a half value of the variation width may be set as the predetermined value PD. In addition, the threshold value TH is not limited to the median value, and for example, an average value may be used as the threshold value TH. The method of setting the threshold value TH is not limited to these examples and can be appropriately changed in accordance with the environment of the optical transmission system 100.

A target of update when the optical signal is switched is a channel Ch as a path of the switched optical signal and adjacent channels Vh on both sides thereof. Although not illustrated in FIGS. 5 and 7, the ranges Rb and Rc also include waveforms of the adjacent channels Ch. Therefore, if the power value of the optical signal of one channel Ch in the steady state varies, then the power values measured from the ranges Rb and Rc of the adjacent channels Ch also vary. Therefore, the adjacent channels Ch are also targets of the update.

In a case where the optical signal of the channel Ch2 illustrated in FIG. 3 is switched, for example, the threshold value setter 13 updates the threshold values TH1, TH2, and TH3 of the channel Ch2. The threshold value setter 13 updates the threshold value TH3 of the channel Ch1 that is adjacent to the channel Ch2 on the left side. The threshold value setter 13 also updates the threshold value TH1 of the channel Ch3 that is adjacent to the channel Ch2 on the right side. In other words, the threshold value setter 13 updates a total of five threshold values.

Hereinafter, description will be given by using processing of the controller 10 of the monitoring device 1.

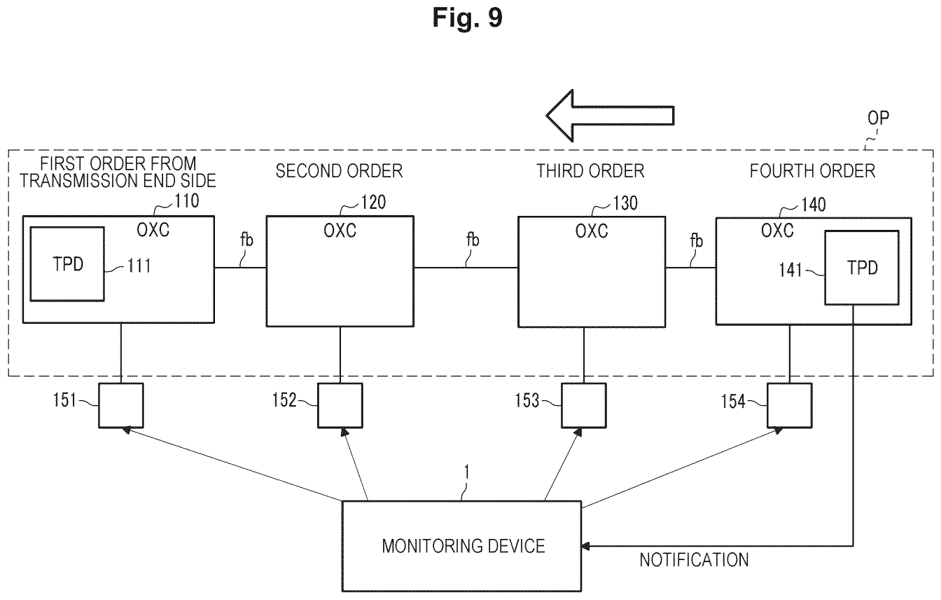

FIG. 9 is a diagram for explaining an example of abnormality determination processing.

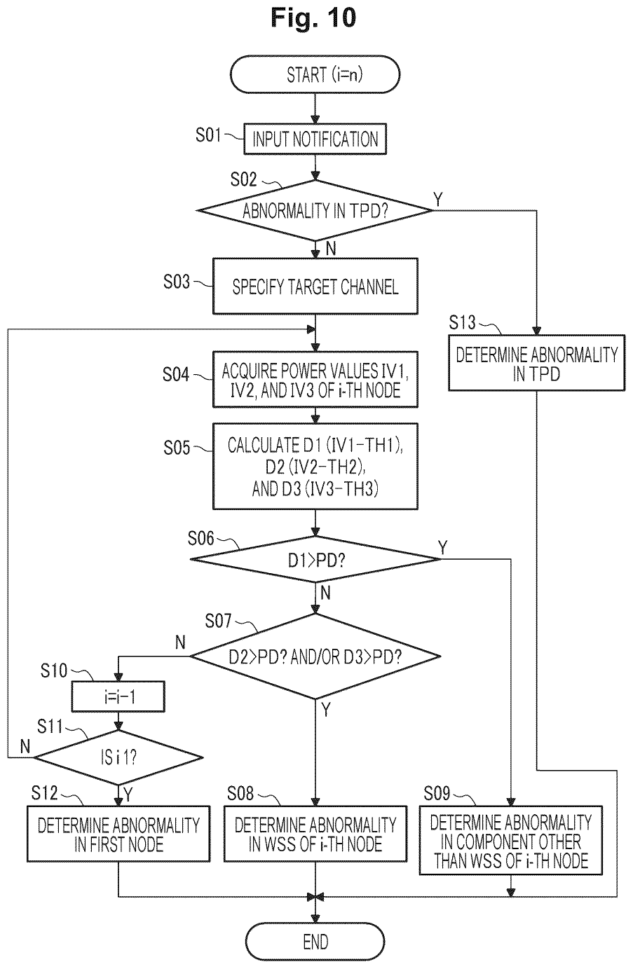

FIG. 10 is a flowchart illustrating a flow of abnormality determination processing.

In FIG. 9, an example in which a notification of deterioration of signal quality is provided from the transponder 141 of the reception end node 140 is illustrated.

As illustrated in FIG. 10, once the transponder 141 detects deterioration of quality of the optical signal, a notification is input to the monitoring device 1 (step S01). In a case where the notification includes abnormality in the transponder 141 itself (step S02: Yes), the controller 10 determines the abnormality in the transponder 141 (step S13) and provides a notification of the abnormality in the transponder 141 via the input/output port 15.

In a case where the notification does not include abnormality in the transponder 141 itself (step S02: No), the controller 10 moves on to step S03.

The data acquisitor 11 specifies the target channel Tch which is the path of the optical signal in which the deterioration has been detected (step S03). The data acquisitor 11 acquires the power values IV1, IV2, and IV3 of the target channel Tch of the i-th node (step S04).

An initial value of i is set to the number n of nodes, and the i-th is a number counted from the transmission end node 110 side. In the example of FIG. 9, n=4. As illustrated in FIG. 9, the abnormality determination processing is performed from the side of the reception end node 140 to the side of the transmission end node 110 in reverse order of numbers. In the example of FIG. 9, the abnormality determination processing is performed from the fourth reception end node 140.

The data acquisitor 11 controls, through the node controller 154 of the reception end node 140, the optical channel monitor 106 to acquire the power values IV1, IV2, and IV3 measured in the ranges Ra, Rb, and Rc, respectively.

As illustrated in FIG. 10, the determinator 12 calculates a difference D1 between the power value IV1 and the threshold value TH1, a difference D2 between the power value IV2 and the threshold value TH2, and a difference D3 between the power value IV2 and the threshold value TH3 (step S05).

In a case where the difference D1 exceeds the predetermined value PD (step S06: Yes), the determinator 12 determines abnormality in a component other than the WSS 103 of the i-th node (step S09). The determinator 12 notifies the user of the determination result via the input/output port 15.

In a case where the difference D1 does not exceed the predetermined value PD (step S06: No), the determinator 12 moves on to step S07.

In a case where at least one of the difference D2 and the difference D3 exceeds the predetermined value PD (step S07: Yes), the determinator 12 determines abnormality in the WSS 103 of the i-th node (step S08). The determinator 12 notifies the user of the determination result via the input/output port 15.

In a case where both the difference D2 and the difference D3 do not exceed the predetermined value PD (step S07: No), the determinator 12 ends the abnormality determination processing of the i-th node and sets “i=i−1” (step S10).

If i is not 1 (step S11: No), the determinator 12 returns to step S04 and performs abnormality determination processing of the i-th node. In other words, the determinator 12 moves on to the node that is adjacent to the node, on which the abnormality determination processing has been ended, on the transmission end side and similarly performs the abnormality determination processing.

In a case where i is 1 (step S11: Yes), the determinator 12 determines abnormality in the first node (transmission end node 110) (step S12) and leaves the determination result for the user. In other words, in a case where the abnormality determination processing of the node 120 is ended in step S10, it means that no abnormality has been determined in the nodes 140, 130, and 120. In this case, it means that abnormality has occurred in the remaining transmission end node 110, it is thus possible to determine the abnormality by a process of elimination without performing the abnormality determination processing for the transmission end node 110. The determinator 12 can notify the user of the abnormality in the transmission end node 110 via the input/output port 15. Note that the abnormality determination processing may also be performed on the transmission end node 110 to determine whether the cause of the abnormality is the WSS 103 or an element other than the WSS 103.

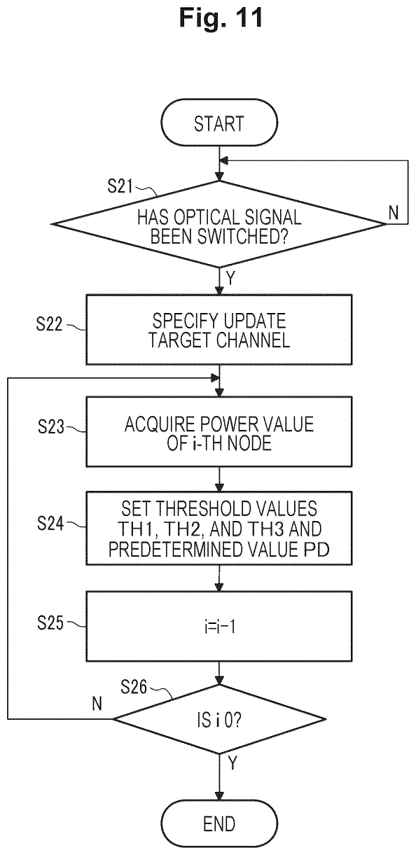

FIG. 11 is a flowchart illustrating a flow of threshold value setting processing.

The threshold value setter 13 determines whether there has been switching such as wave amplification, wave attenuation, and a change in path of the optical signal transmitted through the optical path OP (step S21). If there has been switching (step S21: Yes), then the threshold value setter 13 specifies update target channels (step S22). The update target channels are the channel (switching channel) that is a path of the switched optical signal and the channels adjacent to it on both sides.

The threshold value setting processing can be performed in the opposite order from the side of the reception end node 140 to the side of the transmission end node 110 similarly to the abnormality determination processing.

The threshold value setter 13 controls the optical channel monitor 106 via the node controller 154 of the i-th node and acquires the power values of the update target channels Ch (step S23). The threshold value setter 13 acquires the power values of the ranges Ra, Rb, and Rc for the switching channel. For the adjacent channels, the power value of any one of the ranges Rb and Rc including the waveform of the switching channel is acquired. The threshold value setter 13 acquires each piece of time-series data by acquiring each power value for a certain period of time.

The threshold value setter 13 sets the threshold values TH1, TH2, and TH3 and the predetermined value PD from the time-series data of the ranges Ra, Rb, and Rc (step S24). The threshold value setter 13 updates the threshold values TH1, TH2, and TH3 and the predetermined value PD by causing the storage 16 to store them.

The threshold value setter 13 ends the threshold value setting processing for the i-th node and sets “i=i−1” (step S25).

If i is not 0 (step S26: No), the threshold value setter 13 returns to step S23 and moves on to the threshold value setting processing of the i-th node. In other words, the threshold value setter 13 moves on to the node adjacent to the node, on which the threshold value setting processing has been ended, on the transmission end side and similarly performs the threshold value setting processing.

If i is 0 (step S26: Yes), the threshold value setter 13 ends the processing since the threshold value setting processing for all the nodes 110, 120, 130, and 140 has been completed.

### <Hardware Configuration>

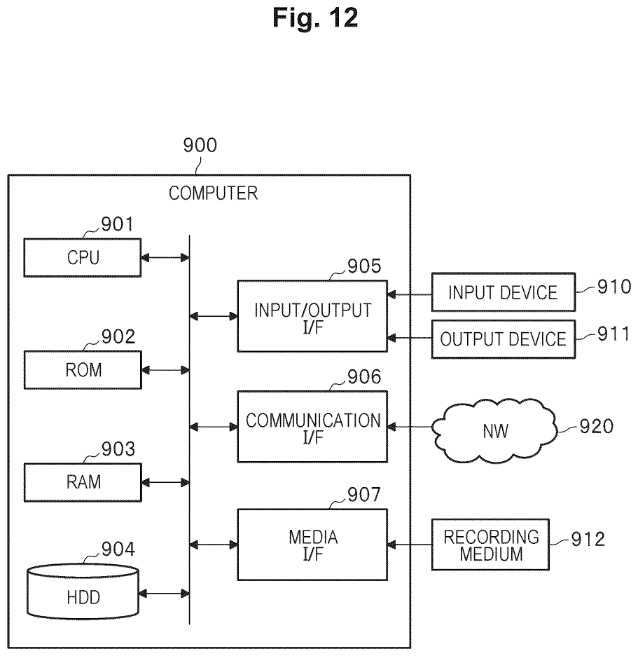

The monitoring device 1 according to the present embodiment is implemented by a computer 900 as illustrated in FIG. 12, for example.

FIG. 12 is a hardware configuration diagram illustrating an example of the computer 900 that implements functions of the monitoring device 1 according to the present embodiment.

The computer 900 includes a central processing unit (CPU) 901, a read only memory (ROM) 902, a random access memory (RAM) 903, a hard disk drive (HDD) 904, an input/output interface (I/F) 905, a communication I/F 906, and a media I/F 907.

The CPU 901 operates on the basis of a program (monitoring program) stored in the ROM 902 or the HDD 904, and performs control by the controller 10 of the monitoring device 1 illustrated in FIG. 4. The ROM 902 stores a boot program to be executed by the CPU 901 when the computer 900 is started, a program related to hardware of the computer 900, and the like.

The CPU 901 controls an input device 910, such as a mouse or a keyboard, and an output device 911, such as a display, via the input/output I/F 905. The CPU 901 acquires data from the input device 910 and outputs generated data to the output device 911 via the input/output I/F 905. Note that a graphics processing unit (GPU) or the like may be used as a processor together with the CPU 901.

The HDD 904 stores a program to be executed by the CPU 901, data to be used by the program, and the like. The communication I/F 906 receives data from other devices such as node controllers 151, 152, 153, and 154 (see FIG. 1) via a communication network (for example, network (NW) 920), outputs the data to the CPU 901, and transmits data generated by the CPU 901 to other devices via the communication network.

The media I/F 907 reads a program or data stored in a recording medium 912, and outputs the program or data to the CPU 901 via the RAM 903. The CPU 901 loads a program related to target processing from the recording medium 912 into the RAM 903 via the media I/F 907 and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

In a case where the computer 900 functions as the monitoring device 1 according to the present embodiment, for example, the CPU 901 of the computer 900 implements the functions of the monitoring device 1 by executing the program loaded on the RAM 903. Further, the HDD 904 stores data in the RAM 903. The CPU 901 reads the program related to the target processing from the recording medium 912 and executes the program. Additionally, the CPU 901 may read the program related to the target processing from other devices via the communication network (NW 920).

### <Configuration of the Above Embodiment and Operational Effects Thereof>

(1) The monitoring device 1 monitors a transmission device (Node 110, 120, 130, 140) that transmits an optical wavelength multiplexed signal including optical signals of a plurality of channels Ch1, Ch2, and Ch3.

The monitoring device 1 includes the data acquisitor 11 and the determinator 12.

The data acquisitor 11 acquires the power value IV1 (first power value) of the range Ra (first range) including the entire wavelength of the target channel Tch (channel) and acquires the power values IV2 and IV3 (second power value) of the ranges Rb and Rc (second range) including parts of the wavelength of the target channel Tch, from the optical channel monitor 106 (monitor) that measures the power values of the optical signal output from the nodes 110, 120, 130, and 140.

The determinator 12 compares the power values IV1, IV2, and IV3 with the threshold values TH1, TH2, and TH3 based on the power values of the nodes 110, 120, 130, and 140 in the steady state and determines abnormality in the nodes 110, 120, 130, and 140.

According to the monitoring device 1 of the present embodiment, it is possible to improve abnormality determination accuracy of the nodes 110, 120, 130, and 140 even in a case where measurement values acquired from the low-resolution optical channel monitor 106 are used. In this manner, it is possible to reduce the installation costs as compared with a case where a monitor with high resolution such as an OSA is provided at each node. Furthermore, since the amount of data acquired from the monitor is reduced, it is possible to reduce a communication load.

Specifically, the monitoring device 1 performs processing for specifying the nodes 110, 120, 130, or 140 in which abnormality has occurred on the optical path OP that is a communication path when deterioration of quality of the optical signal is detected by the transponder 141 of the reception end node 140.

The data acquisitor 11 of the monitoring device 1 acquires the power value of the optical signal of the target channel Tch in which the abnormality has been detected, from the optical channel monitor 106 provided on the output side of each of the nodes 110, 120, 130, and 140.

The data acquisitor 11 acquires the power value IV1 (first power value) of the range Ra (first range) covering the entire wavelength of the target channel Tch. The determinator 12 compares the power value IV1 with the threshold value TH1 set on the basis of the power value of the range Ra in the steady state. In a case where the difference D1 between the power value IV1 and the threshold value TH1 exceeds the predetermined value PD due to abnormality in the waveform of the target channel Tch, the determinator 12 can determine the abnormality in the node that has output the optical signal.

Here, there may be a case where it is not possible to determine abnormality in the filter function of the WSS 103 of the nodes 110, 120, 130, and 140 only by the processing of comparing the power value IV1 and the threshold value TH1.

The node controllers 151, 152, 153, and 154 perform power control to compensate for a waveform loss caused by the filtering of the WSS 103. This also applies to the case where a loss occurs due to abnormality in the filter function of the WSS 103.

Therefore, the power of the entire waveform due to the filter abnormality in the WSS 103 may become the same as the power of the waveform in the steady state. In this case, the difference D1 between the power value IV1 acquired from the range Ra covering the entire wavelength and the threshold value TH1 may not become large to exceed the predetermined value PD. In this case, the abnormality in the nodes 110, 120, 130, and 140 cannot be determined.

In the present embodiment, the data acquisitor 11 acquires the power values IV2 and IV3 (second power value) in ranges Rb and Rc (second range) including parts of the wavelength of the target channel Tch in addition to the power value IV1. The determinator 12 also compares the power values IV2 and IV3 with the threshold values TH2 and TH3 set on the basis of the ranges Rb and Rc in the steady state, respectively.

A location with a large difference between the waveform caused by the abnormality and the waveform in the steady state tends to be included by setting the ranges Rb and Rc including parts of the wavelength. Further, since the ranges Rb and Rc do not cover the entire wavelength, the probability that the power value within the range becomes the same as that in the steady state as a result becomes lower than that for the range Ra. Therefore, it is possible to increase the probability that the differences D2 and D3 between the power values IV2 and IV3 of the ranges Rb and Rc and the threshold values TH2 and TH3 exceed the predetermined value PD and abnormality is determined.

(2) The nodes 110, 120, 130, and 140 include a wavelength selective switch 103 (WSS) that multiplexes optical signals of the plurality of channels Ch1, Ch2, and Ch3 to generate an optical wavelength multiplexed signal and filters the optical signals in accordance with the wavelength band BW allocated to each of the channels Ch1, Ch2, and Ch3.

The determinator 12 of the monitoring device 1 determines abnormality in a component (element) other than the WSS 103 in the nodes 110, 120, 130, and 140 on the basis of the comparison between the power value IV1 and the threshold value TH1. The determinator 12 determines abnormality in the WSS 103 on the basis of the comparison between the power values IV2 and IV3 and the threshold values TH2 and TH3.

The probability that a component other than the WSS 103 is a cause is high in a case where abnormality is determined with the power value IV1, and the probability that the WSS 103 is a cause is high in a case where abnormality is determined with the power values IV2 and IV3. The determinator 12 can also cut out the cause of the abnormality among the nodes 110, 120, 130, and 140 by the data acquisitor 11 acquiring the plurality of power values IV1, IV2, and IV3 of the different ranges Ra, Rb, and Rc.

It is thus possible to improve convenience of the monitoring device 1.

(3) The data acquisitor 11 of the monitoring device 1 sets, as the second range, the two ranges Rb and Rc including parts of the wavelength of the target channel Tch (channel) and located at mutually deviating positions and acquires the power values IV2 and IV3 in the ranges Rb and Rc, respectively, as the second power value.

In a case where only the power value IV2 of the range Rb is acquired as the second power value, and a waveform loss is compensated by the power control within the range Rb, the same power as that in the steady state may be achieved as a result. In this case, the difference D2 between the power value IV2 and the threshold value TH2 may not exceed the predetermined value PD and it may not be possible to determine the abnormality in the nodes 110, 120, 130, and 140. The data acquisitor 11 sets, as the second range, the two ranges Rb and Rc located at mutually deviating positions and acquires the power values IV2 and IV3 therefrom as the second power value. A wider range in the channel Ch is covered by the setting of the plurality of ranges, and the probability that the portion with a large difference in power from that in the steady state is captured in either the range Rb or Rc becomes high. The determinator 12 can determine abnormality in the nodes 110, 120, 130, and 140 if at least either the power value IV2 or IV3 exceeds the threshold value TH2 or TH3 and can thus improve accuracy of the abnormality determination.

Note that the number of ranges set as the second range is not limited to two and three or more ranges may be set and a power value of each range may be acquired as the second power value.

(4) The monitoring device 1 includes the threshold value setter 13 that sets the threshold values TH1, TH2, and TH3. The threshold value setter 13 acquires the power values of the channel as a path of the optical signal, on which switching is performed, and of adjacent channels from the optical channel monitor 106 when the optical signal is switched, and sets the threshold values TH1, TH2, and TH3.

Once the optical signal is switched in the optical transmission system 100, the power value of the channel as the path of the switched optical signal in the steady state varies. The threshold value setter 13 updates the threshold values TH1, TH2, and TH3 at the timing of the switching, so that the threshold values TH1, TH2, and TH3 reflect the power value in the steady state, and the accuracy of determining abnormality in the nodes 110, 120, 130, and 140 can thus be improved.

The above effect can also be applied to a monitoring method performed by the monitoring device 1 and a monitoring program for causing the computer 900 to function as the monitoring device 1.

### Modified Embodiment 1

Hereinafter, a modified embodiment 1 of the present embodiment will be described with reference to the drawings.

Detailed description of the same configuration and processing according to the modified embodiment 1 as those of the present embodiment will be omitted.

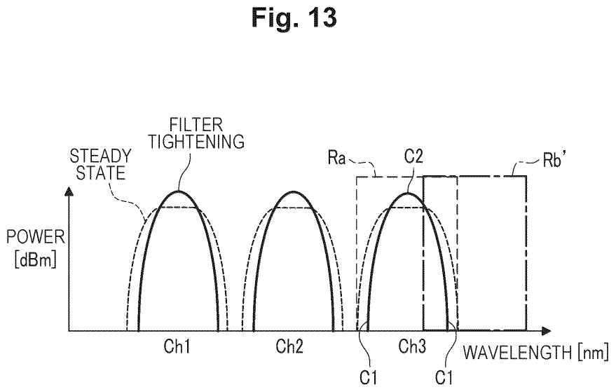

FIG. 13 is a diagram for explaining a range in which a power value is acquired according to the modified embodiment 1.

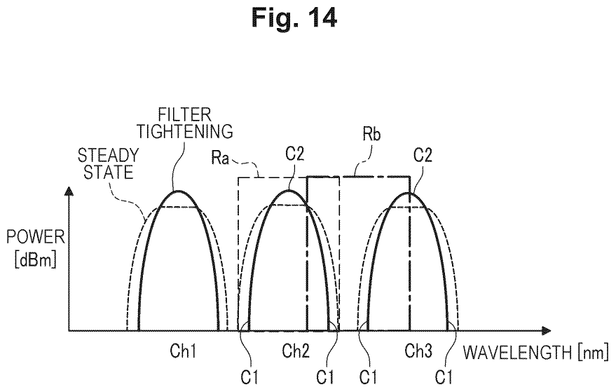

FIG. 14 is a diagram for explaining a comparative example.

Although the example in which the waveform of the specific channel is distorted due to abnormality in the filter function of the WSS 103 has been described in the aforementioned embodiment (see FIG. 6), the abnormality in the filter function may affect the waveforms of all the channels Ch1, Ch2, and Ch3 as illustrated in FIG. 13. In the modified embodiment 1, it is possible to determine the abnormality in the nodes 110, 120, 130, and 140 even when the abnormality occurs in the waveforms of all the channels Ch1, Ch2, and Ch3, by modifying the processing in the aforementioned embodiment.

FIG. 13 illustrates an example in which abnormality called filter tightening occurs in the waveforms of all the channels Ch1, Ch2, and Ch3. In FIG. 13, a waveform in the steady state is indicated by the dotted line, and a waveform of filter tightening is indicated by a solid line. In the waveform of the filter tightening, the power of a component C1 at the end decreases while the power of a component C2 at the center increases as compared with the waveform in the steady state.

Since the configuration of the controller 10 of the monitoring device 1 in the modified embodiment 1 is the same as that in FIG. 4, description will be given with reference to FIG. 4.

Similarly to the embodiment, the controller 10 performs abnormality determination processing in a case where a notification indicating that deterioration of an optical signal has been detected is input from the transponders 111 and 141. The data acquisitor 11 specifies the target channel Tch that is the path of the optical signal in which the deterioration has been detected, and performs the abnormality determination processing of the modified embodiment 1 in a case where all the channels Ch1, Ch2, and Ch3 have been specified as the target channels Tch.

The data acquisitor 11 selects the termination channel from among all the channels Ch1, Ch2, and Ch3. The termination channel means a channel with no other channels are adjacent to any one of both ends of its waveform. In the example of FIG. 13, the channel Ch3 is selected as the termination channel. The channel Ch2 is adjacent to the end of the channel Ch3 on the left side, while no other channels are adjacent to the end thereof on the right side.

Note that the data acquisitor 11 may select the channel Ch1 as the termination channel. The channel Ch2 is adjacent to the end of the channel Ch1 on the right side, while no other channels are adjacent to the end thereof on the left side.

The data acquisitor 11 acquires the power value IV1 of the range Ra including the entire wavelength of the optical signal of the channel Ch3 similarly to the embodiment.

In the modified embodiment 1, the data acquisitor 11 acquires a power value IV2′ of a range Rb′ including the end of the wavelength of the channel Ch3 on the right side to which no other channels are adjacent. The range Rb′ is a range that does not cover the entire wavelength and includes only a part of the wavelength.

Note that in a case where the channel Ch1 is regarded as the termination channel, the data acquisitor 11 acquires the power value IV2′ from the range Rb′ including the end of the channel Ch1 on the left side to which no other channels are adjacent.

FIG. 14 illustrates, as a comparative example, a case where the range Ra and the range Rb are set in the channel Ch2 with both ends to which the channels Ch1 and Ch3 are adjacent, similarly to the embodiment.

As described above, the node controllers 151, 152, 153, and 154 perform power control to compensate for a loss caused by abnormality in the filtering function of the WSS 103. Therefore, as illustrated in FIG. 14, the power of the component C1 at the end decreases as compared with that in the steady state, while the power of the component C2 at the center increases as compared with that in the steady state in the waveform of the filter tightening. In other words, the difference D1 between the power value IV1 of the range Ra and the threshold value TH1 does not become large, and there is a probability that abnormality in the nodes 110, 120, 130, and 140 is not determined even in the case of the filter tightening.

Next, in a case where the range Rb is set in the channel Ch2, the waveform of the adjacent channel Ch3 is also included in the range Rb as illustrated in FIG. 14. The range Rb includes the component C1 at the end where the power of the channels Ch2 and Ch3 decreases, and includes the component C2 at the center where the power of the channel Ch3 increases. In a case where the amount of increase in power and the amount of decrease in power within the range Rb become similar values, the difference D2 between the power value IV2 of the range Rb and the threshold value TH2 does not exceed the predetermined value PD, and there is a probability that abnormality in the nodes 110, 120, 130, and 140 is not determined.

As illustrated in FIG. 13, the data acquisitor 11 sets the range Ra and the range Rb′ in the termination channel Ch3 in the modified embodiment 1. Furthermore, the data acquisitor 11 sets the range Rb′ to include the end of the termination channel Ch3 on the right side to which no other channels are adjacent. In this manner, the waveforms of the adjacent channels are not included in the range Rb′. In other words, the amount of decrease in power due to the component C1 at the end of the channel Ch3 is not cancelled out by the amount of increase of the component C2 at the center of the adjacent channel. Therefore, the power value IV2′ of the range Rb′ is reduced by the component C1 at the end, and a difference D2′ from a threshold value TH2′ tends to exceed the predetermined value PD. It is thus possible to improve accuracy of determining abnormality in the nodes 110, 120, 130, and 140.

Note that the threshold value TH2′ can be set by performing processing that is similar to the threshold value setting processing in the embodiment when the optical signal of the termination channel Ch3 is switched.

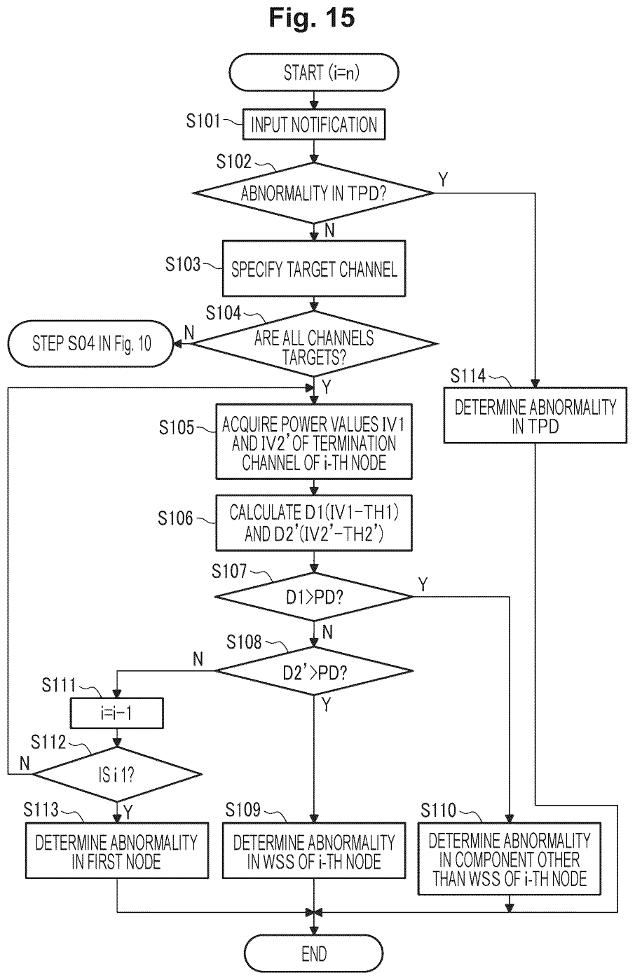

FIG. 15 is a flowchart illustrating a flow of abnormality determination processing according to the modified embodiment 1.

Here, an example in which a notification indicating deterioration of signal quality is provided from the transponder 141 of the reception end node 140 will be described.

As illustrated in FIG. 15, once the transponder 141 detects deterioration of quality of the optical signal, a notification is input to the monitoring device 1 (step S101). In a case where the notification includes abnormality in the transponder 141 itself (step S102: Yes), the controller 10 determines the abnormality in the transponder 141 (step S114) and provides a notification indicating the abnormality in the transponder 141 via the input/output port 15.

In a case where the notification does not include abnormality in the transponder 141 itself (step S102: No), the controller 10 moves on to step S103.

The data acquisitor 11 specifies the target channels Tch that are the path of the optical signal in which the deterioration has been detected (step S103).

In a case where the target channels Tch are not all the channels Ch1, Ch2, and Ch3 (step S104: No), the data acquisitor 11 moves on to the processing in step S04 in FIG. 10 and performs the same abnormality determination processing as that in the embodiment.

In a case where the target channels Tch are all the channels Ch1, Ch2, and Ch3 (step S104: Yes), the data acquisitor 11 selects the channel Ch3 which is the termination channel. The data acquisitor 11 acquires the power values IV1 and IV2′ from each of the ranges Ra and Rb′ of the termination channel Ch3 of the i-th node (step S105).

As illustrated in FIG. 15, the determinator 12 calculates the difference D1 between the power value IV1 and the threshold value TH1 and the difference D2′ between the power value IV2′ and the threshold value TH2′ (step S106).

In a case where the difference D1 exceeds the predetermined value PD (step S107: Yes), the determinator 12 determines abnormality in a component other than the WSS 103 of the node (step S110). The determinator 12 notifies the user of the determination result via the input/output port 15.

In a case where the difference D1 does not exceed the predetermined value PD (step S107: No), the determinator 12 moves on to step S108.

In a case where the difference D2′ exceeds the predetermined value PD (step S108: Yes), the determinator 12 determines abnormality in the WSS 103 of the node (step S109). The determinator 12 notifies the user of the determination result via the input/output port 15.

In a case where the difference D2′ does not exceed the predetermined value PD (step S108: No), the determinator 12 ends the abnormality determination processing of the i-th node and sets “i=i−1” (step S111).

If i is not 1 (step S112: No), the determinator 12 returns to step S105 and performs abnormality determination processing of the i-th node. In a case where i is 1 (step S112: Yes), the determinator 12 determines abnormality in the transmission end node 110 which is the first node (step S113).

### <Configuration of Modified Embodiment 1 and Operational Effects Thereof>

(5) In the modified embodiment 1, the data acquisitor 11 of the monitoring device 1 sets, as the second range, the range Rb′ including an end of the wavelength of the termination channel Ch3 to which no other channels are adjacent and acquires the power value IV2′ (second power value).

In a case where filter tightening occurs in the wavelength of all the channels Ch1, Ch2, and Ch3, the range Rb set to include a part of the channels Ch may include the wavelength of the adjacent channel Ch. Since filter tightening has occurred in the wavelength of the adjacent channel Ch as well, the difference D2 between the power value IV2 of the range Rb and the threshold value TH2 does not exceed the predetermined value PD, and there is a probability that it is not possible to determine abnormality in the nodes 110, 120, 130, and 140. In a modified embodiment 2, the range Rb′ is set to include the ends of the termination channels Ch1 and Ch3 to which no other channels are adjacent. The power value IV2′ of the range Rb′ is not affected by the adjacent channels in this manner, the probability that the difference D2′ between the power value IV2′ and the threshold value TH2′ exceeds the predetermined value PD when filter tightening occurs increases, and it is thus possible to improve accuracy of determining abnormality in the nodes 110, 120, 130, and 140.

In FIG. 15, the example in which the two power values IV1 and IV2′ are acquired from the termination channel Ch3 and abnormality determination processing is performed in a case where the target channels Tch are all the channels Ch1, Ch2, and Ch3 (step S104: YES) has been described. In the example of FIG. 15, only two power values have to be acquired, and it is thus possible to reduce the amount of data processing at the time of the abnormality determination processing.

Note that the present invention is not limited to the example in FIG. 15, and the processing may be proceeded to step S04 in FIG. 10, the power values IV1, IV2, and IV3 are sequentially acquired from the ranges Ra, Rb, and Rc for each channel, and the abnormality determination processing may be performed even in a case where the target channels are all the channels Ch1, Ch2, and Ch3. In that case, the range Rb is set to include the end of the channel. In this manner, IV2′ of the range Rb′ is acquired as a result of acquiring the power value IV2 from the range Rb at the termination channel, and it is thus possible to determine abnormality in the node due to filter tightening as well. The determinator 12 can end the abnormality determination processing when abnormality is determined in any of the channels.

### Modified Embodiment 2

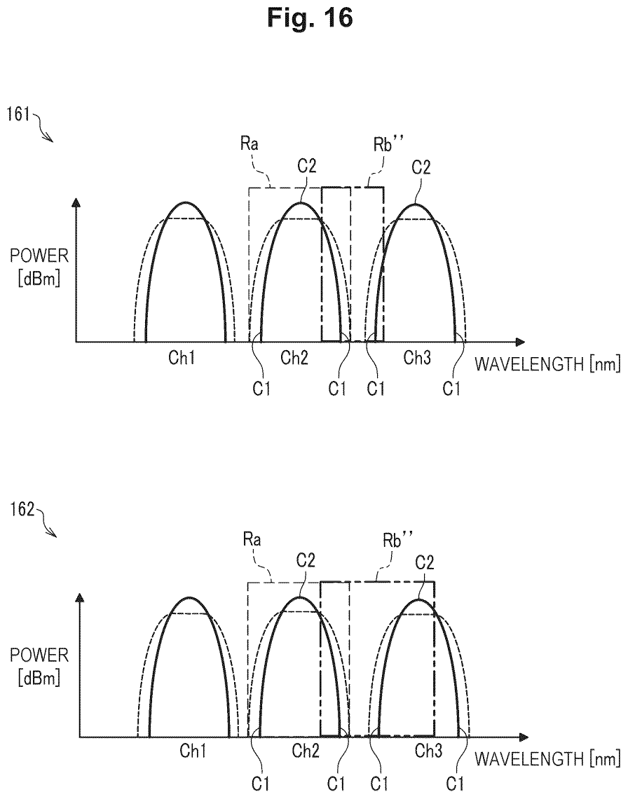

FIG. 16 is a diagram for explaining a range in which a power value is acquired according to the modified embodiment 2.

In the modified embodiment 1, the waveform of the adjacent channel is prevented from being included by setting the range Rb′ at the channel Ch3 which is the termination channel when filter tightening occurs.

In the modified embodiment 2, a range Rb″ is set such that it is possible to determine abnormality even in a channel with channels being adjacent to both ends thereof when filter tightening occurs. FIG. 16 illustrates an example in which the range Rb″ is set in the channel Ch2.

Specifically, the data acquisitor 11 sets a range Rb″ having a width that is different from that of the range Ra covering the entire wavelength and including the end of the wavelength of the channel Ch2. The data acquisitor 11 acquires a power value IV2″ of the range Rb″ from the optical channel monitor 106. Although the range Rb″ is set to include the right end in FIG. 16, the range Rb″ may be set to include the left end.

Similarly to the embodiment, the determinator 12 calculates a difference D2″ between the power value IV2″ of the range Rb″ and a threshold value TH2″. The determinator 12 determines abnormality in the node if the difference D2″ exceeds the predetermined value PD.

The threshold value TH2″ can be set by performing processing similar to the threshold value setting processing in the embodiment.

As illustrated in the diagram of the reference sign 161 in FIG. 16, the width of the range Rb″ may be narrower than the range Ra. In this manner, the range Rb″ does not include the component C2 at the center where the power of the adjacent channel Ch3 increases. In this manner, the amount of decrease in power due to the component C1 at ends of the channels Ch2 and Ch3 is not cancelled out by the amount of increase due to the component C2 at the center, and the power value IV2″ of the range Rb″ becomes small. This leads to an increase in difference D2″ between the power value IV2″ and the threshold value TH2″ and abnormality is easily determined.

As illustrated in the diagram of the reference sign 162 in FIG. 16, the width of the range Rb″ may be wider than the range Ra. The proportion at which the component C2 at the center of the channel Ch3 is included in the range Rb″ increases by widening the range Rb″. If the amount of increase in power due to the component C2 at the center of the range Rb″ is larger than the amount of decrease in power due to the component C1 at the end, then the power value IV2″ of the range Rb″ becomes large. This leads to an increase in difference D2″ between the power value IV2″ and the threshold value TH2″ and abnormality is easily determined.

The data acquisitor 11 changes the widths of the range Ra and the range Rb″ by changing the setting of the resolution of the optical channel monitor 106 via the node controllers 151, 152, 153, and 154. It is possible to narrow the width of the range Rb″ as illustrated in the drawing of the reference sign 161 in FIG. 16 by making the resolution of the optical channel monitor 106 finer. It is possible to widen the width of the range Rb″ as illustrated in the drawing of the reference sign 162 in FIG. 16 by roughening the resolution of the optical channel monitor 106.

### <Configuration of Modified Embodiment 2 and Operational Effects Thereof>

(6) The data acquisitor 11 of the monitoring device 1 sets, as the second range, the range Rb″ having a width that is different from that of the range Ra (first range) and including an end of the wavelength of the channel and acquires the power value IV2″ (second power value).

It is possible to differentiate the proportion of the component (component C1) by which the power is decreased and the component (component C2) by which the power is increased, included in the range Rb″ by setting the range Rb″ with a width that is different from that of the range Ra covering the entire wavelength. This leads to an increase in difference D2″ between the power value IV2″ and the threshold value TH2″, and it is possible to improve accuracy of determining abnormality in the node.

According to the modified embodiment 2, it is possible to determine abnormality in the node not only at the termination channel but also a channel with channels Ch being adjacent to both ends thereof and thereby to improve convenience of the monitoring device 1.

The processing of the modified embodiment 2 can be performed in a case where the target channels Tch are all the channels Ch1, Ch2, and Ch3 (step S104: Yes) similarly to the processing illustrated in FIG. 15 in the modified embodiment 1. In that case, the data acquisitor 11 can select an arbitrary channel from all the channels Ch1, Ch2, and Ch3, acquire the two power values IV1 and IV2″ of the two ranges Ra and Rb″, and perform the abnormality determination processing. Since only the two power values have to be acquired in this case similarly to the modified embodiment 1, it is possible to reduce the amount of data processing in the monitoring device 1. Note the data acquisitor 11 may acquire both the power value of the range Rb″ with a widen width and the power value of the range Rb″ with a narrowed width.

Also, the present invention is not limited to the example in FIG. 15, and the processing may proceed to step S04 in FIG. 10 and sequentially perform the abnormality determination processing on each channel even in a case where the target channels are not all the channels Ch1, Ch2, and Ch3. At that time, the power value IV2″ of the range Rb″ is acquired in addition to the acquisition of the power values IV1, IV2, and IV3 from the ranges Ra, Rb, and Rc for each channel. The determinator 12 can end the abnormality determination processing when abnormality is determined in any of the channels.

### Modified Embodiment 3

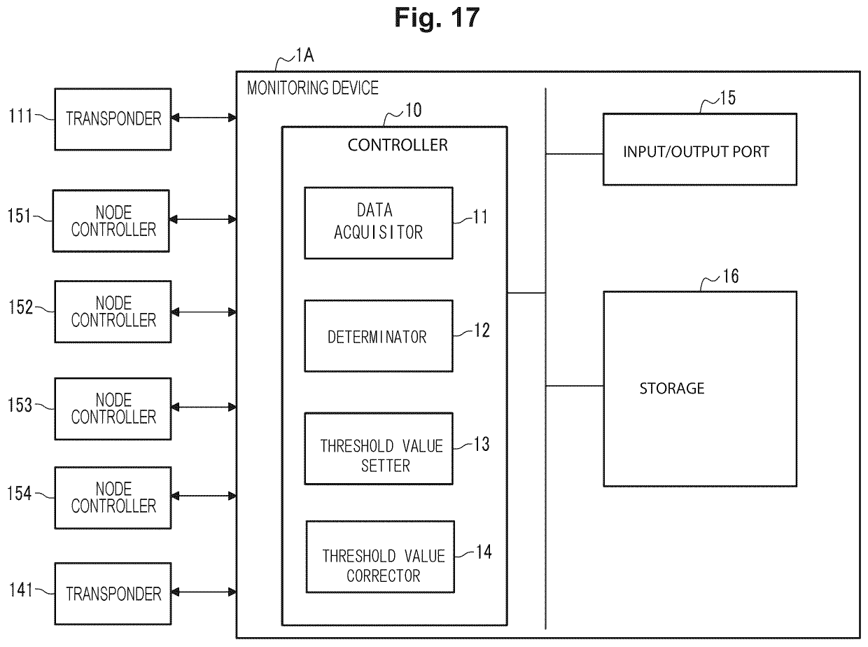

FIG. 17 is a functional block diagram illustrating a configuration of a monitoring device 1A according to a modified embodiment 3.

As illustrated in FIG. 17, the monitoring device 1A according to the modified embodiment 3 has a threshold value corrector 14 in addition to the configurations described in the embodiment.

In the modified embodiment 3, the data acquisitor 11 acquires the power values IV1, IV2, and IV3 from the ranges Ra, Rb, and Rc, respectively, in the target channel Tch of each node similarly to the embodiment. At that time, the data acquisitor 11 causes the optical channel monitor 106 to perform the measurement for a predetermined time T only for the power value IV1 of the range Ra to acquire data of the power value IV1 for the predetermined time T.

The threshold value setter 13 determines whether there have been variations in power value IV1 from the data for the predetermined time T acquired by the data acquisitor 11. In a case where there have been variations in power value IV1, the threshold value setter 13 sets an offset value on the basis of the amount of variations. The threshold value setter 13 corrects the threshold values TH1, TH2, and TH3 by adding the determined offset value to each of the threshold values TH1, TH2, and TH3.

The determinator 12 compares the power values IV1, IV2, and IV3 with the corrected threshold values TH1, TH2, and TH3 thereby to perform the abnormality determination processing similarly to the embodiment.

Although a constant power value IV1 is typically output from the WSS 103 if the grid width has not been changed, there may be a case where the power value IV1 is not constant and varies due to a cause such as severe environmental conditions. It is possible to perform abnormality determination processing in accordance with the environmental conditions by the threshold value setter 13 determining the offset value on the basis of the amount of variations in the power value IV1 and correcting the threshold values TH1, TH2, and TH3.

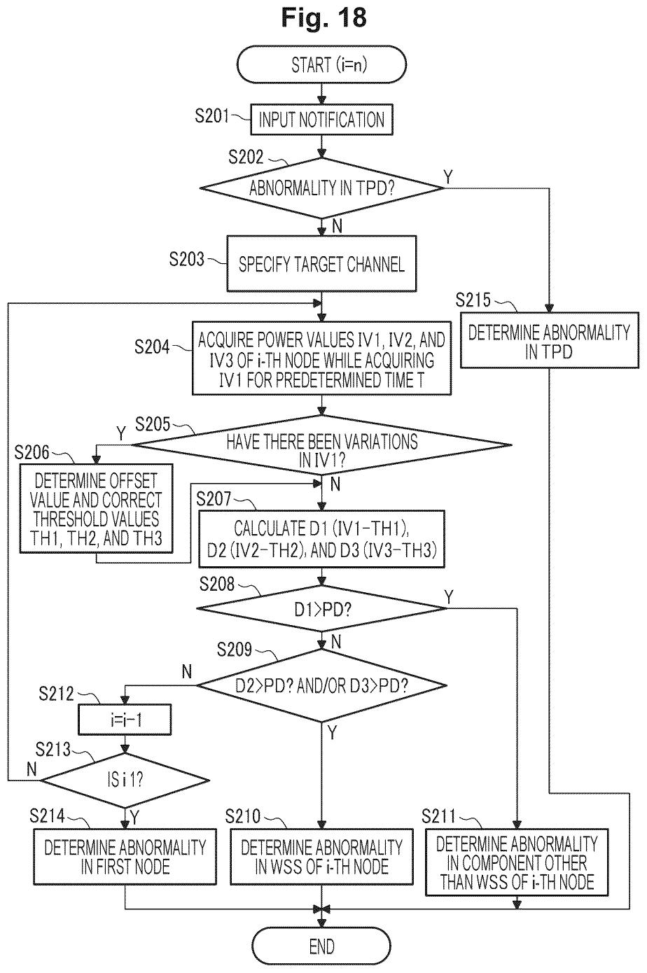

FIG. 18 is a flowchart illustrating a flow of threshold value correction processing according to the modified embodiment 3.

The processing in steps S201 to S203 illustrated in FIG. 18 is the same as the processing in steps S01 to S03 illustrated in FIG. 10, and description thereof will thus be omitted.

In step S204, the data acquisitor 11 acquires the power values IV1, IV2, and IV3 from the ranges Ra, Rb, and Rc, respectively in the target channel Tch of the i-th node. The data acquisitor 11 acquires data for the predetermined time T in regard to the power value IV1.

The threshold value corrector 14 refers to the data for the predetermined time T of the power value IV1 and determines whether there have been variations in the power value IV1 (step S205). If there have been no variations in the power value IV1 (step S205: No), the threshold value corrector 14 inputs the threshold values TH1, TH2, and TH3 to the determinator 12 without correcting them.

If there have been variations in the power value IV1 (step S205: Yes), the threshold value corrector 14 determines the offset value from the amount of variations and corrects the threshold values TH1, TH2, and TH3 by adding the offset value thereto (step S206). The threshold value corrector 14 inputs the corrected threshold values TH1, TH2, and TH3 to the determinator 12.

The determinator 12 calculates differences D1, D2, and D3 between the power values IV1, IV2, and IV3 and the threshold values TH1, TH2, and TH3 input from the threshold value corrector 14 (step S207).

The processing in steps S208 to S215 is the same as the processing in steps S06 to S13 in FIG. 10, and description thereof will thus be omitted.

### <Configuration of Modified Embodiment 3 and Operational Effects Thereof>

(7) The monitoring device 1A includes the threshold value corrector 14 that corrects the threshold values TH1, TH2, and TH3 on the basis of the amount of variations in the power value IV1 (first power value) in the predetermined time T acquired by the data acquisitor 11.

In this manner, it is possible to improve accuracy of determining abnormality in the node even under environmental conditions in which the power values IV1, IV2, and IV3 vary.

Although the examples in which the monitoring device is applied to the network controller that manages the entire optical transmission system 100 has been described in the aforementioned embodiment and modified embodiments, the present invention is not limited thereto. The monitoring device may be applied to the node controller 151 to 154 that control the nodes 110 to 140, respectively.

Alternatively, some functional configurations of the monitoring device 1 may be implemented by the node controllers 151, 152, 153, and 154. For example, the threshold values may be set by the network controller, and the abnormality determination processing may be performed by each of the node controllers 151, 152, 153, and 154.

Note that the present invention is not limited to the above-described embodiment, and many modifications can be made by those skilled in the art within the technical idea of the present invention.

### REFERENCE SIGNS LIST

1 Monitoring device
11 Data acquisitor
12 Determinator
13 Threshold value setter
14 Threshold value corrector
15 Input/output port
16 Storage
110, 120, 130, 140 Node (transmission device, OXC)
103 Wavelength selective switch (WSS)
106 Optical channel monitor (monitor)
Ra Range (first range)
Rb, Rb′, Rb″, Rc Range (second range)
IV1 Power value (first power value)
IV2, IV2′, IV2″, IV3 Power value (second power value)

1. A monitoring device for a transmission device that transmits an optical wavelength multiplexed signal including optical signals of a plurality of channels, the monitoring device comprising:
a data acquisitor that acquires a first power value of a first range including an entire wavelength of the channels and acquires a second power value of a second range including a part of wavelength of the channels from a monitor measuring power values of the optical signals output from the transmission device; and
a determinator that compares each of the first power value and the second power value with a threshold value based on a power value of the transmission device in a steady state and determines abnormality in the transmission device.

2. The monitoring device according to claim 1,
wherein the transmission device includes a wavelength selective switch that multiplexes the optical signals of the plurality of channels to generate the optical wavelength multiplexed signal and filters the optical signals in accordance with a wavelength band assigned to each channel, and
the determinator determines abnormality in an element other than the wavelength selective switch in the transmission device on the basis of comparison between the first power value and the threshold value and determines abnormality in the wavelength selective switch on the basis of comparison between the second power value and the threshold value.

3. The monitoring device according to claim 1, wherein the data acquisitor sets, as the second range, two ranges including some of the wavelengths of the channels and located at mutually deviating positions and acquires a power value in each of the two ranges as the second power value.

4. The monitoring device according to claim 1, wherein the data acquisitor
sets, as the second range, a range of the wavelengths of the channels including an end to which no other channels are adjacent and acquires the second power value.

5. The monitoring device according to claim 1, wherein the data acquisitor
sets, as the second range, a range having a width that is different from a width of the first range and including an end of the wavelengths of the channels and acquires the second power value.

6. The monitoring device according to claim 2, comprising
a threshold value setter that sets the threshold value,
wherein when the optical signal is switched, the threshold value setter acquires power values of a channel that is a path of the optical signal which has been switched and of an adjacent channel from the monitor and sets the threshold value.

7. A monitoring method of a transmission device that transmits an optical wavelength multiplexed signal including optical signals of a plurality of channels, the monitoring method comprising the steps of:
acquiring a first power value of a first range including an entire wavelength of the channels and acquiring a second power value of a second range including a part of the wavelength of the channels from a monitor that measures power values of the optical signals output from the transmission device; and
comparing each of the first power value and the second power value with a threshold value based on a power value of the transmission device in a steady state and determining abnormality in the transmission device.

8. A non-transitory storage medium storing a monitoring program for causing a computer to function as the monitoring device according to claim 1.
